(19) United States
(12) Patent Application Publication
(10) Pub. No.: US 2026/0044717 A1
(43) Pub. Date: Feb. 12, 2026

(54) COMPUTING SYSTEMS AND METHODS FOR A TEXT-TO-SQL GENERATIVE ARTIFICIAL INTELLIGENCE TRAINING AND CHAT

(71) Applicant: The Toronto-Dominion Bank, Toronto (CA)

(72) Inventors: Satya Krishna GORTI, Toronto (CA); Ilan GOFMAN, Toronto (CA); Zhaoyan LIU, Toronto (CA); Rasa HOSSEINZADEH, Toronto (CA); Jiapeng WU, Toronto (CA); Jesse Cole CRESSWELL, Toronto (CA); Guangwei YU, Toronto (CA); Maksims VOLKOVS, Toronto (CA); Noël Vouitsis, Markham (CA)

(21) Appl. No.: 18/799,621

(22) Filed: Aug. 9, 2024

(51) Int. Cl. G06N 3/0475; G06N 3/092

(52) U.S. Cl. CPC G06N 3/0475; G06N 3/092

(57) ABSTRACT

Systems and methods are provided for executing a structured query language (SQL) large language model (LLM). A computing system includes a SQL LLM stored in memory and executable by the processor. The processor accesses a SQL dataset with natural language questions, metadata, and sets of SQL code. It generates a synthetic SQL dataset with synthetic natural language questions, metadata, and sets of SQL code. The synthetic and original datasets are combined to create a combined SQL dataset. The SQL LLM is then trained on this combined SQL dataset to output a trained SQL LLM.

### TECHNICAL FIELD

The disclosed exemplary embodiments relate to computer-implemented systems and methods for generating Structured Query Language (SQL) from text using generative artificial intelligence.

### BACKGROUND

Structured Query Language (SQL) is a programming language designed for managing and manipulating data in relational database management systems. SQL uses SQL queries to interact with the database. SQL queries are requests for specific data or modifications to existing data. SQL commands are used to perform various actions such as retrieving data from a database table, adding new data to a table, modifying data to a table, and deleting data. SQL uses a database schema to define the structure of the database including tables, columns, data types, and relationships.

### SUMMARY

The following summary is intended to introduce the reader to various aspects of the detailed description, but not to define or delimit any invention.

In at least one broad aspect, a computing system is provided for executing a structured query language (SQL) large language model (LLM). The computing system comprising: a memory, a communication interface, and a processor operatively coupled to the memory and the communication interface; and the SQL LLM stored in the memory and executable by the processor. The processor is configured to: access a SQL dataset comprising a plurality of natural language questions, metadata for one or more databases associated with each one of the plurality of natural language questions, and a plurality of sets of SQL code respectively associated with the plurality of natural language questions; generate a synthetic SQL dataset comprising a plurality of synthetic natural language questions, synthetic metadata for the one or more databases associated with each one of the plurality of synthetic natural questions, and a plurality of synthetic sets of SQL code respectively associated with the plurality of synthetic natural questions; combine the synthetic SQL dataset and the SQL dataset to generate a combined SQL dataset; and train the SQL LLM on the combined SQL dataset to output a trained SQL LLM.

In some cases, the processor is further configured to obtain a preference dataset comprising a further plurality of natural language questions, a respective plurality of correct answers, and a respective plurality of incorrect answers; and, after training the SQL LLM on the combined SQL dataset, further training the SQL LLM using the preference dataset to output a further trained SQL LLM.

In some cases, the further training the SQL LLM using the preference dataset comprises rewarding the SQL LLM generating training answers that match the respective plurality of correct answers.

In some cases, a synthesizer LLM uses the SQL dataset to generate the synthetic SQL dataset.

In some cases, the computing system further comprise a retrieval system in the memory, and wherein the processor is further configured to: receive a given natural language question; generate a prompt that comprises the given natural language question and a database schema corresponding to a given database from amongst the one or more databases; process, using a retrieval system, the prompt to identify one or more tables in the database, the one or more tables relevant to the given natural language question; generate, using the retrieval system, an augmented prompt that comprises the given natural language question, the database schema, and one or more identities of the one or more tables; generate, using the trained SQL LLM, a set of SQL code based on the augmented prompt; initiate executing the set of SQL code on the given database and receiving a result; generate a result message using the result; and provide the result message responsive to the given natural language question.

In some cases, the computing system further comprises a preliminary LLM in the memory, and the preliminary LLM generates the prompt that comprises the given natural language question, the database schema and metadata of the given database; wherein the retrieval system comprises a retrieval LLM, and the retrieval LLM processes the prompt to identify the one or more tables in the given database and a subset of the metadata of the given database that corresponds to the one or more tables; and wherein the retrieval LLM generates the augmented prompt that further comprises the metadata of the given database and the subset of the metadata of the given database.

In some cases, the processor is further configured to at least: identify, using the retrieval system, one or more rows in the one or more tables that are relevant to the given natural language question; and establish one or more row indexes of the one or more rows as the subset of the metadata of the given database.

In some cases, the processor is further configured to at least: identify, using the retrieval system, one or more columns in the one or more tables that are relevant to the given natural language question; and establish one or more column headings of the one or more columns as the subset of the metadata of the given database.

In some cases, when the result comprises an error message, the processor is configured to: generate a new set of SQL code, using the trained SQL LLM, based on the augmented prompt; initiate executing the new set of SQL code on the given database; and receive a new result comprising retrieved data from the database that is responsive to the new set of SQL code.

In some cases, a chat user interface is stored in the memory; and the processor is further configured to: receive the given natural language question via the chat user interface; generate the result message in a form of a natural language response that comprises the result; and provide the natural language response via the chat user interface.

In at least another broad aspect, a method is provided for executing a structured query language (SQL) large language model (LLM). The method is executed in a computing environment comprising one or more processors, a communication interface, and memory that stores the SQL LLM. The method comprises: accessing a SQL dataset comprising a plurality of natural language questions, metadata for one or more databases associated with each one of the plurality of natural language questions, and a plurality of sets of SQL code respectively associated with the plurality of natural language questions; generating a synthetic SQL dataset comprising a plurality of synthetic natural language questions, synthetic metadata for the one or more databases associated with each one of the plurality of synthetic natural questions, and a plurality of synthetic sets of SQL code respectively associated with the plurality of synthetic natural questions; combining the synthetic SQL dataset and the SQL dataset to generate a combined SQL dataset; and training the SQL LLM on the combined SQL dataset to output a trained SQL LLM.

In some cases, the method further comprises obtaining a preference dataset comprising a further plurality of natural language questions, a respective plurality of correct answers, and a respective plurality of incorrect answers; and, after training the SQL LLM on the combined SQL dataset, further training the SQL LLM using the preference dataset to output a further trained SQL LLM.

In some cases, the further training the SQL LLM using the preference dataset comprises rewarding the SQL LLM generating training answers that match the respective plurality of correct answers.

In some cases, a synthesizer LLM uses the SQL dataset to generate the synthetic SQL dataset.

In some cases, the method further comprises, after outputting the further trained SQL LLM: receiving a given natural language question; generating a prompt that comprises the given natural language question and a database schema corresponding to a given database from amongst the one or more databases; processing, using a retrieval system, the prompt to identify one or more tables in the given database, the one or more tables relevant to the given natural language question; generating, using the retrieval system, an augmented prompt that comprises the given natural language question, the database schema, and one or more identities of the one or more tables; generating, using the trained SQL LLM, a set of SQL code based on the augmented prompt; initiating executing the set of SQL code on the given database and receiving a result; generating a result message using the result; and providing the result message responsive to the given natural language question.

In some cases, the method further comprises a preliminary LLM generating the prompt that comprises the given natural language question, the database schema and metadata of the given database; wherein the retrieval system comprises a retrieval LLM, and the retrieval LLM processes the prompt to identify the one or more tables in the given database and a subset of the metadata of the given database that corresponds to the one or more tables; and wherein the retrieval LLM generates the augmented prompt that further comprises the metadata of the given database and the subset of the metadata of the given database.

In some cases, the method further comprises: identifying, using the retrieval system, one or more rows in the one or more tables that are relevant to the given natural language question; and establishing one or more row indexes of the one or more rows as the subset of the metadata of the given database.

In some cases, the method further comprises: identifying, using the retrieval system, one or more columns in the one or more tables that are relevant to the given natural language question; and establishing one or more column headings of the one or more columns as the subset of the metadata of the given database.

In some cases, the result comprises an error message, the method further comprising: generating a new set of SQL code, using the trained SQL LLM, based on the augmented prompt; initiating executing the new set of SQL code on the given database; and receive a new result comprising retrieved data from the given database that is responsive to the new set of SQL code.

According to some aspects, the present disclosure provides a non-transitory computer-readable medium storing computer-executable instructions. The computer-executable instructions, when executed, configure a processor to perform any of the methods described herein. For example, a non-transitory computer readable medium is provided storing computer executable instructions which, when executed by at least one computer processor, cause the at least one computer processor to carry out one or more methods for machine learning as described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1A is a schematic block diagram of a system for processing documents in accordance with at least some embodiments;

FIG. 1B is a schematic block diagram of a cloud-based computing cluster of FIG. 1A, including a computing system for generating SQL from text using a generative artificial intelligence chat system, in accordance with at least some embodiments;

FIG. 1C is a schematic block diagram of a training system cluster of FIG. 1B, in accordance with at least some embodiments;

FIG. 2 is a block diagram of a computer in accordance with at least some embodiments;

FIG. 3 is a schematic block diagram of example data components used in generating SQL from text using a generative artificial intelligence chat system, in accordance with at least some embodiments;

FIG. 4 is a flowchart diagram of an example method of training a SQL large language model (LLM), in accordance with at least some embodiments;

FIG. 5 is a flowchart diagram of an example method of generating SQL code in response to receiving a natural language question, in accordance with at least some embodiments;

FIG. 6 is a flowchart diagram of another example method of generating SQL code in response to receiving a natural language question, in accordance with at least some embodiments; and

FIG. 7 is a flowchart diagram of establishing metadata used in an augmented prompt for generating SQL code, in accordance with at least some embodiments.

### DETAILED DESCRIPTION

A computing system is provided that processes a natural language query using SQL. In some cases, the computing system generates SQL from text using a generative artificial intelligence chat system. In some cases, a SQL LLM is included and is trained using a synthetic SQL dataset. In some cases, the SQL LLM is further trained using a preference data that includes correct answers and incorrect answers.

In some cases, while organizations use SQL databases for data consistency and integrity, as well as ease of use, interacting with SQL database can be challenging. In some cases, complex SQL database designs could lead to complex SQL queries being used to access the desired data from the SQL database. In some cases, updates or modifications to an existing SQL database would cause previously used to SQL queries to no longer work with the updated or modified SQL database. In some cases, it is also difficult for users to master SQL concepts and to effectively interact with the SQL database. In some cases, these challenges make it difficult for a user, which does not know how to create SQL code, to effectively obtain data from SQL databases. The term “SQL code” herein refers to SQL statements that are executable by computing system to interact with a database. In some cases, the SQL code includes SQL queries or SQL commands, or both.

In some cases, a computing system is provided for executing a structured query language (SQL) large language model (LLM). The computing system includes: a memory, a communication interface, and a processor operatively coupled to the memory and the communication interface; and the SQL LLM stored in the memory and executable by the processor. The processor is configured to: access a SQL dataset comprising a plurality of natural language questions, metadata for one or more databases associated with each one of the plurality of natural language questions, and a plurality of sets of SQL code respectively associated with the plurality of natural language questions; generate a synthetic SQL dataset comprising a plurality of synthetic natural language questions, synthetic metadata for the one or more databases associated with each one of the plurality of synthetic natural questions, and a plurality of synthetic sets of SQL code respectively associated with the plurality of synthetic natural questions; combine the synthetic SQL dataset and the SQL dataset to generate a combined SQL dataset; and train the SQL LLM on the combined SQL dataset to output a trained SQL LLM.

In some cases, the computing system provides a chat user interface (UI) that facilitates a chatting user experience between a user and the computing system. The chat UI receives a natural language query from the user, and the natural language query is processed to generate SQL code to retrieve data of interest to the user.

In some cases, rich information is stored in databases of an organization, along with additional metadata that contains information about the database fields. In some cases, using the computing system provided herein, a user with simple questions no longer needs to write and run database queries in computing languages like SQL. In some cases, users are not required to have knowledge of computer programming nor keep track of database architectures. In some cases, users no longer need to parse data sources that contain information about the databases. Instead, in some cases the computing system is used to receive plain language questions from the user, and the plain language questions (also called natural language questions) processed by the computing system to automatically generate, using a large language model, structured database queries. The structured database queries are run automatically in a database environment and the results are returned to the user. In some cases, the results are processed and presented as a plain language result that is presented to the user. In some cases, the structured database queries are also presented to the user for their reference.

In some cases, the one or more LLMs (e.g., including the SQL LLM) in the computing system are trained (or fine-tuned) on a large-scale dataset that contains natural language questions along with additional metadata needed for solving the natural language question that maps to an optimal SQL statement. The datasets are expanded to have more details by using existing language models to obtain a richer synthetic dataset.

In some cases, the one or more LLMs are further optimized by obtaining preference datasets by collecting different samples from the LLM predictions providing a rich dataset of correct answers and wrong answers for every question in the dataset. The one or more LLMs are then trained by an objective that rewards the generation of preferred answers.

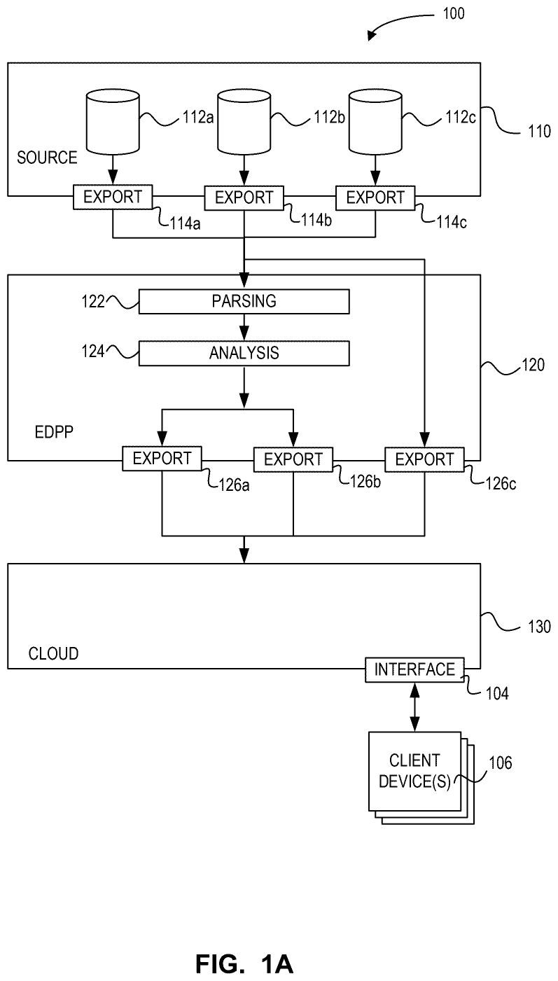

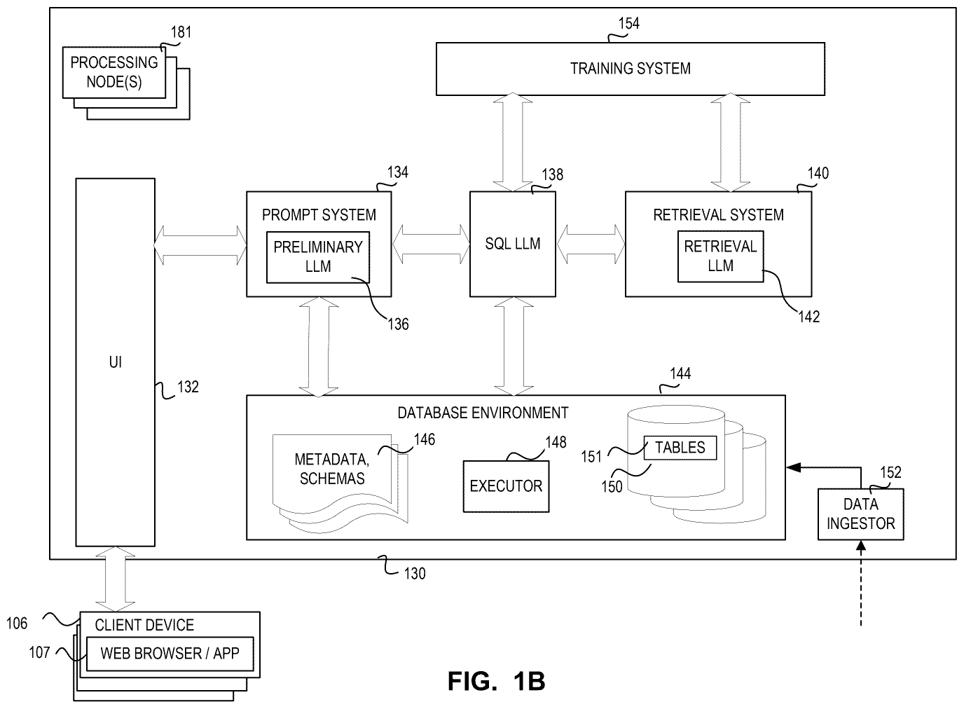

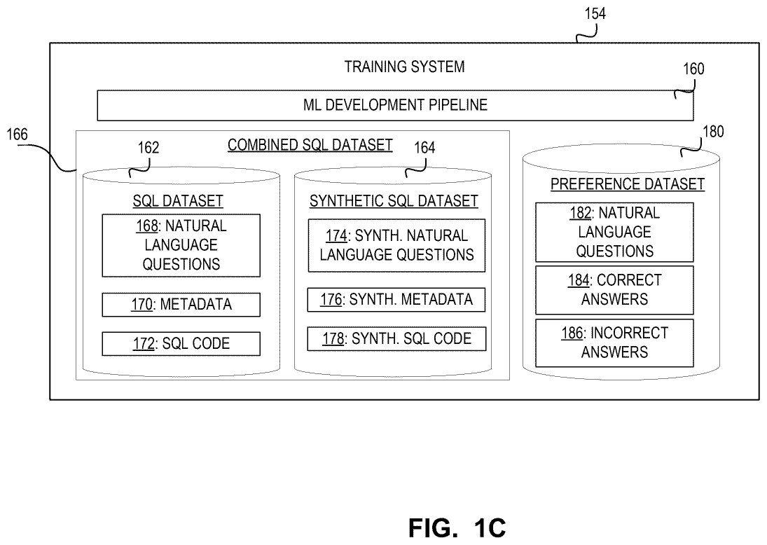

Referring now to FIG. 1A, there is illustrated a block diagram of an example computing system, in accordance with at least some embodiments. Computing system 100 has a source database system 110, an enterprise data provisioning platform (EDPP) 120 operatively coupled to the source database system 110, and a cloud-based computing cluster 130 that is operatively coupled to the EDPP 120. In some cases. this computing system 100 is provided for automated data processing of large data sets, including identify relevant documents to automatically generate responses in relation to a given query. In some cases, the documents are files that include text. In some cases, different data formats of documents or files (or both), and which include text, can be used in the computing system described herein.

Source database system 110 has one or more databases, of which three are shown for illustrative purposes: database 112a, database 112b and database 112c. One or more the databases of the source database system 110 may contain confidential information that is subject to restrictions on export. One or more export modules 114a, 114b, 114c may periodically (e.g., daily, weekly, monthly, etc.) export data from the databases 112a, 112b, 112c to EDPP 120. In some instances, the data is exported on an ad hoc basis.

EDPP 120 receives source data exported by the export modules 114 of source database system 110, processes it and exports the processed data to an application database within the cloud-based computing cluster 130. For example, a parsing module 122 of EDPP 120 may perform extract, transform and load (ETL) operations on the received source data.

In many environments, access to the EDPP may be restricted to relatively few users, such as administrative users. However, with appropriate access permissions, data relevant to a document or group of documents (e.g., a client document) may be exported via reporting and analysis module 124 or an export module 126. In particular, parsed data can then be processed and transmitted to the cloud-based computing cluster 130 by a reporting and analysis module 124. Alternatively, one or more export modules 126a, 126b, 126c can export the parsed data to the cloud-based computing cluster 130.

In some cases, there may be confidentiality and privacy restrictions imposed by governmental, regulatory, or other entities on the use or distribution of the source data. These restrictions may prohibit confidential data from being transmitted to computing systems that are not “on-premises” or within the exclusive control of an organization, for example, or that are shared among multiple organizations, as is common in a cloud-based environment. In particular, such privacy restrictions may prohibit the confidential data from being transmitted to distributed or cloud-based computing systems, where it can be processed by machine learning systems, without appropriate anonymization or obfuscation of personal identifiable information (PII) in the confidential data. Moreover, such “on-premises” systems typically are designed with access controls to limit access to the data, and thus may not be resourced or otherwise suitable for use in broader dissemination of the data. In some cases, to comply with such restrictions, one or more module of EDPP 120 may “de-risk” data tables that contain confidential data prior to transmission to cloud-based computing cluster 130. In some cases, this de-risking process may obfuscate or mask elements of confidential data, or may exclude certain elements, depending on the specific restrictions applicable to the confidential data. The specific type of obfuscation, masking or other processing is referred to as a “data treatment.”

The cloud-based computing cluster 130 includes an interface 104, which facilitates data communication with one or more client devices 106.

In some environments, the EDPP may be omitted.

Referring now to FIG. 1B, there is illustrated a block diagram of the cloud-based computing cluster 130, showing greater detail of the elements of the cloud-based computing cluster, which may be implemented by computing nodes of the cluster that are operatively coupled.

The components of the cloud-based computing cluster 130 include a user interface (UI) 132, a prompt system 134, a SQL LLM 138, a retrieval system 140, a database environment 144, a data ingestor 152, and a training system 154. In some cases, these components are configured to operate on a single computing node and, in some other cases, the components operate on multiple computing nodes. In some cases, the one or more computing nodes are herein referred to as a computing system.

In some cases, the training system 154 trains the SQL LLM 138. In some cases, the training system 154 trains a retrieval LLM 142 that is part of the retrieval system 140.

In some cases, the UI 132 receives data from a client device 106, and presents data to the client device 106. In some cases, the UI 132 is a chat UI that is configured to receive natural language from the client device 106 and provide natural language response to the client device 106. In some cases, the natural language is in the form of text. In some cases, the natural language is in the form of speech or audible data, which is converted to text, using speech-to-text processing. In some cases, the chat UI includes a graphical component that shows the natural language inputted by the user, and the chat UI shows the natural language response provided by the computing system. In some cases, the chat UI is displayable on a web browser or an app 107 on the client device 106.

In some cases, the prompt system includes a preliminary LLM 136. In some cases, the prompt system 134 provides the natural language chatting functionality that is received by and outputted from the UI 132. In some cases, the preliminary LLM 136 initially processes a natural language query. In some cases, the preliminary LLM 136 presents a result message from the SQL LLM 138 in a format responsive to the natural language question provided by the user, so as to provide a conversational experience between the user (via their client device 106) and the computing system.

In some cases, the prompt system 134 obtains metadata about the database and database schema 146 from the database environment 144. The metadata about the database and database schema 146 are used to characterize the database environment 144, including information about the one or more tables 151 in the database environment. In some cases, the prompt system 134 generates a prompt that includes the natural language question and database information. In some cases, the database information includes the database schema and the metadata of the database environment. In some cases, the database schema or the metadata, or both, are provided to the prompt system 134 in the form of a JavaScript Object Notation (JSON) file.

In some cases, the prompt system 134 and the UI 132 are integrated into one node. In some other cases, the prompt system 134 and the UI 132 are separate nodes.

In some cases, the SQL LLM 138 communicates with the prompt system 134, the retrieval system 140 and the database environment 144. The SQL LLM 138 is configured to receive a prompt that includes natural language and, responsive to the prompt, generate a set of SQL code. The set of SQL code is transmitted to the database environment 144, and the database environment 144 executes the SQL code.

In some cases, the SQL LLM 138 is trained to generate sets of SQL code responsive to natural language questions.

In some cases, the retrieval system 140 is configured to determine which tables are relevant to a natural language question and to transmit the identified tables back to the SQL LLM 138. In some cases, the retrieval system 140 also identifies relevant row indexes, or column headings, or both, within the relevant tables.

In some cases, the retrieval system 140 includes a retrieval LLM 142 that generates an augmented prompt that comprises the natural language question, the database schema, and one or more identities of one or more tables that were identified as relevant to the natural language question. In some cases, the augmented prompt further includes the relevant row indexes, or column headings, or both, within the relevant tables.

In some cases, the database environment 144 communicates with the prompt system 134 and the SQL LLM 138. In some cases, the database environment 144 also communicates with the retrieval system 140. In some cases, the database environment 144 encapsulates one or more databases 150 which may allow for more efficient access to the databases. In some cases, each database 150 includes one or more tables 151. In some cases, the database environment 144 is an off-prem database. In some other cases, the database environment 144 is an on-prem database. In some cases, there are multiple database environments, and the prompt system 134 and the SQL LLM 138 communicate with the multiple database environments.

In some cases, the database environment 144 includes metadata about the database and database schema 146. In some cases, the database schema defines how data is organized within a relational database; this is inclusive of logical constraints such as, table names, fields, data types and the relationships between these entities. In some cases, metadata is “the data about the data”, and includes information that describes the database—as opposed to being the contents of the database. In some cases, metadata includes column names, database names, user names, and version names. In some cases, metadata also includes string results from a SQL command SHOW. In some cases, metadata includes the contents of tables in the SQL command INFORMATION_SCHEMA, which may include information about database objects.

In some cases, a given database 150 includes one or more tables 151 storing data, which can be queried using SQL.

In some cases, the database environment 144 includes an executor 148 that executes SQL commands to retrieve, create, edit, or delete data, or a combination thereof.

In some cases, the data ingestor 152 provides data from one or more other sources to the database environment 144.

In some cases, components described in FIG. 1B, including the UI 132, the prompt system 134, the SQL LLM 138, the retrieval system 140, the database environment 144, and the data ingestor 152, are implemented as one or more processing nodes 181 in the cloud-based computing cluster. In some cases, these components are implemented as virtual computing machines within the cloud-based computing cluster.

Turning to FIG. 1C, a block diagram of a training system 154 is provided according to some embodiments. In some cases, the training system 154 includes a machine learning pipeline 160 that is used to train a LLM, such as the SQL LLM or the retrieval LLM, or both.

In some cases, the training system 154 includes a SQL dataset 162. In some cases, the SQL dataset 162 includes a plurality of natural language question 168, and each natural language question is associated with metadata 170 regarding one or more databases in the database environment 144, and a set of SQL code 172. In some cases, an entry in the SQL dataset 162 includes: a natural language question, a corresponding metadata entry, and a corresponding set of SQL code.

The metadata 170 regarding the one or more databases in the database environment 144 is used to identify one or more data values that are relevant to a given natural language question. The set of SQL code 172 is executable by the database environment to obtain the one or more data values that are relevant to a given natural language question.

In some cases, the training system 154 includes a synthetic SQL dataset 164. In some cases, the synthetic SQL dataset 164 is generated by the training system 154 using the SQL dataset 162. In some cases, the synthetic SQL dataset 164 includes a plurality of synthetic natural language questions 174, synthetic metadata 176 that corresponds to each of the plurality of synthetic natural language questions 174, and a synthetic set of SQL code 178 that corresponds to each of the plurality of synthetic natural language questions 174. In some cases, an entry in the synthetic SQL dataset 164 includes: a synthetic natural language question, a corresponding synthetic metadata entry, and a corresponding synthetic set of SQL code.

In some cases, the training system 154 includes a synthetic LLM that generates the synthetic SQL dataset 164 using the SQL dataset 162.

In some cases, the SQL dataset 162 and the synthetic SQL dataset 164 are combined to generate a combined SQL dataset 166. The combined SQL dataset 166 is used to train the SQL LLM, which results in a trained SQL LLM.

In some cases, the trained SQL LLM is further trained using a preference dataset 180. In some cases, the preference dataset 180 includes a plurality of natural language questions 182, and each natural language question is associated with one or more correct answers 184 and one or more incorrect answers 186. The trained SQL LLM is trained using the preference dataset 180, and, when the trained SQL LLM generates training answers to a given natural language question that matches a correct answer 184, then the trained SQL LLM is rewarded. This additional training results in a further trained SQL LLM. In some cases, this further training is referred to as fine tuning.

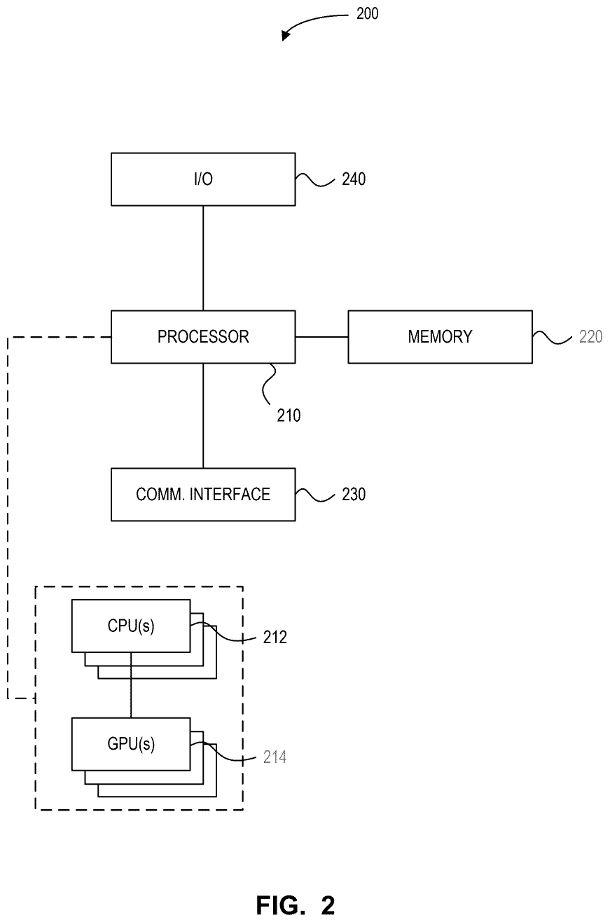

Referring now to FIG. 2, there is illustrated a simplified block diagram of a computer 200 in accordance with at least some embodiments. The computer 200 is also herein interchangeably called a computing system. Computer 200 is an example implementation of a computer such as source database system 110, EDPP 120, processing node 181 of FIGS. 1A and 1B. Computer 200 has at least one processor 210 operatively coupled to at least one memory 220, at least one communications interface 230 (also herein called a network interface), and at least one input/output device 240.

The at least one memory 220 includes a volatile memory that stores instructions executed or executable by processor 210, and input and output data used or generated during execution of the instructions. Memory 220 may also include non-volatile memory used to store input and/or output data—e.g., within a database—along with program code containing executable instructions.

Processor 210 may transmit or receive data via communications interface 230, and may also transmit or receive data via any additional input/output device 240 as appropriate.

In some cases, the processor 210 includes a system of central processing units (CPUs) 212. In some other cases, the processor includes a system of one or more CPUs and one or more Graphical Processing Units (GPUs) 214 that are coupled together. For example, ML model executes neural network computations on CPU and GPU hardware, such as the system of CPUs 212 and GPUs 214.

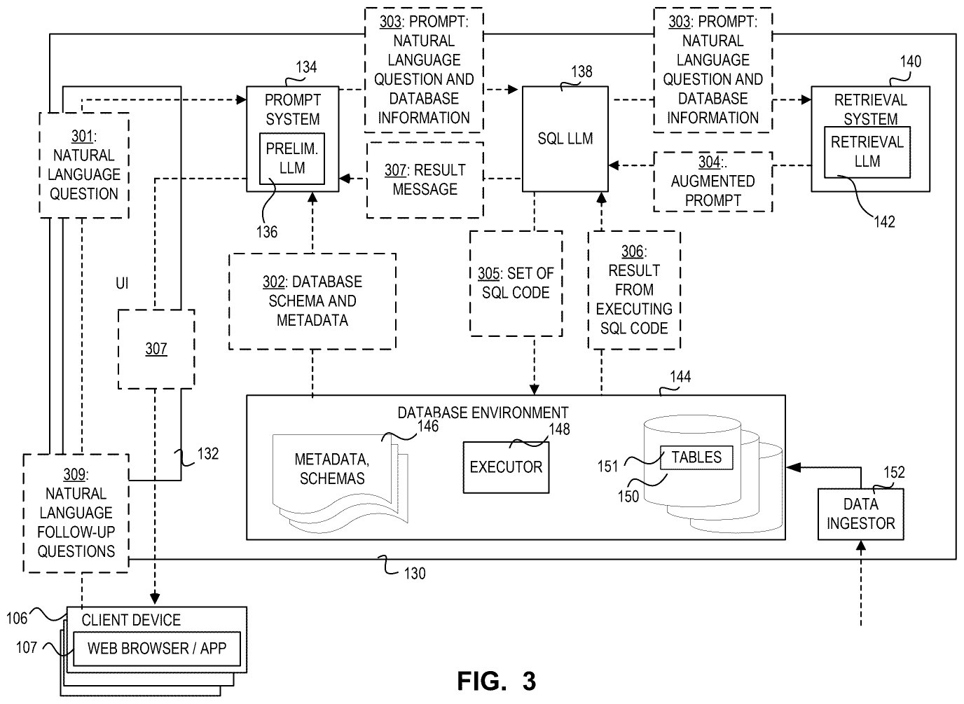

Referring now to FIG. 3, an example embodiment of a computing system for processing a natural language question using SQL is provided, including showing some of the data components.

In some cases, a user uses the client device 106 to input a natural language question 301, which is transferred to the UI 132. In some cases, the natural language question is, “How many people from location X have performed an action Y in the time period Z?”. In some cases, the natural language question is, “Show me all the entities that meet these criteria: A, B and C.” Other types and formats of natural language questions can be used.

The natural language question 301 is transmitted to the prompt system 134.

In some cases, the prompt system 134 receives database information 302 that includes a database schema or metadata, or both, about the database environment 144.

In some cases, the prompt system 134 generates a prompt 303 that includes the natural language question 301 and the database information 302.

The prompt 303 is transmitted to the retrieval system 140. The retrieval system processes the prompt 303 to determine which tables are relevant to the natural language question 301. In some cases, the retrieval system 142 includes a retrieval LLM 142 and uses the retrieval LLM 142 to generate an augmented prompt 304. In some cases, the augmented prompt 304 includes the natural language question, the database schema, and one or more identities of one or more tables that are relevant to the natural language question.

In some other cases, the retrieval system 140 sends the one or more identities of one or more tables that are relevant to the natural language question to the SQL LLM 138, and the SQL LLM 138 generates the augmented prompt 304.

The SQL LLM 138 processes the augmented prompt 304 to generate a set of SQL code 305. The SQL code 305 is executed by the database environment 144, which generates a result 306 from executing the SQL code.

In some cases, the result includes retrieved data from the database that is relevant to the natural language question.

In some cases, the SQL LLM 138 generates a result message 307 based on the result 306. In some cases, the result message 307 comprises the retrieved data. The result message 307 is transmitted to the client device 106 via the UI 132.

In some cases, the natural language question is received via a chat user interface, which is the UI 132. In some cases, the result message 307 is in a form of a natural language response that comprises the result, and the natural language response is sent to the client device 106 via the chat user interface.

In some cases, the result message 307 comprises a tabulated format of the result 306, which includes structured data retrieved from one or more databases.

In some other cases, when the result 306 comprises an error message, the process includes generating a new set of SQL code, using the SQL LLM 138, based on the augmented prompt 304. The process further includes then initiating executing the new set of SQL code on the database and receiving a new result comprising retrieved data from the database that is responsive to the new set of SQL code. When the new result does not include an error message and includes one or more data values obtained from the one or more tables in the database, then the SQL LLM uses the new result to generate a result message.

In some cases, after the client device 106 receives the result message 307, the user provides one or more natural language follow-up questions 309 via the UI 132. The operations for processing the previous natural language question 301 are similarly repeated using the one or more natural language follow-up questions 309.

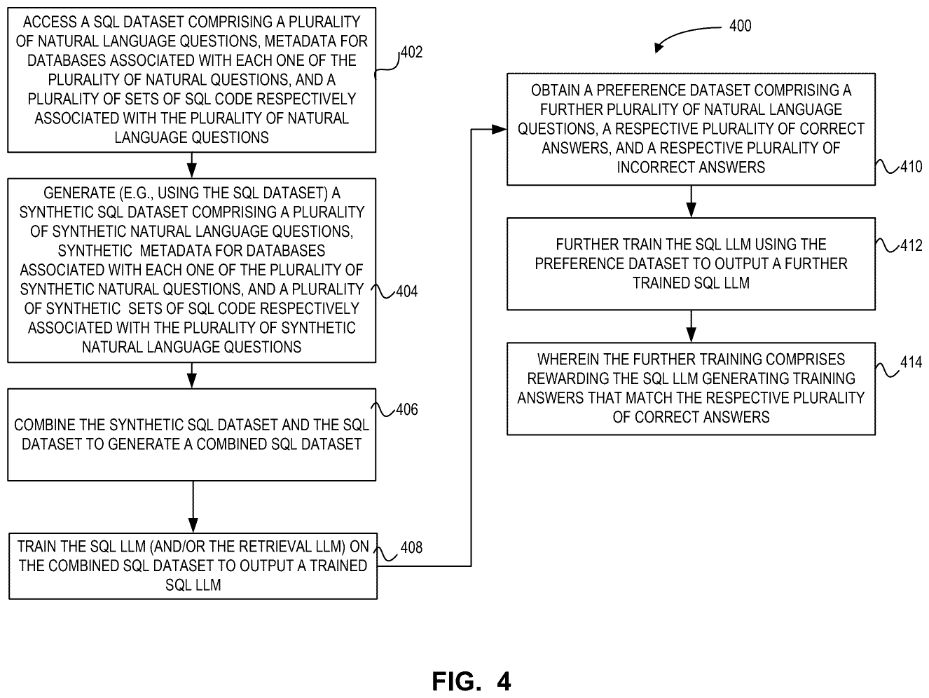

Referring now to FIG. 4, a computing process 400 for training a SQL LLM is provided, according to an example embodiment.

Block 402: Access a SQL dataset comprising a plurality of natural language questions, metadata for databases associated with each one of the plurality of natural questions, and a plurality of sets of SQL code respectively associated with the plurality of natural language questions.

Block 404: Generate (e.g., using the SQL dataset) a synthetic SQL dataset comprising a plurality of synthetic natural language questions, synthetic metadata for databases associated with each one of the plurality of synthetic natural questions, and a plurality of synthetic sets of SQL code respectively associated with the plurality of synthetic natural language questions.

Block 406: Combine the synthetic SQL dataset and the SQL dataset to generate a combined SQL dataset.

Block 408: Train the SQL LLM (and/or the retrieval LLM) on the combined SQL dataset to output a trained SQL LLM.

Block 410: Obtain a preference dataset comprising a further plurality of natural language questions, a respective plurality of correct answers, and a respective plurality of incorrect answers.

Block 412: Further train the s SQL LLM using the preference dataset to output a further trained SQL LLM.

Block 414: Wherein the further training comprises rewarding the SQL LLM generating training answers that match the respective plurality of correct answers.

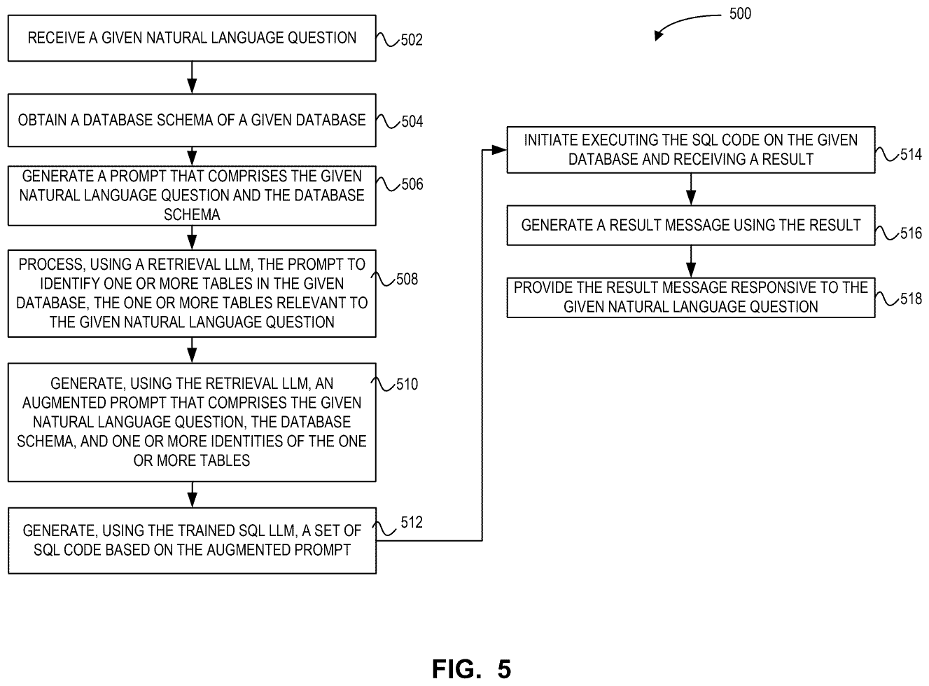

Referring now to FIG. 5, a computing process 500 for processing a natural language question using SQL is provided.

Block 502: Receive a given natural language question.

Block 504: Obtain a database schema of a given database from amongst the one or more database in the database environment.

Block 506: Generate a prompt that comprises the given natural language question and the database schema.

Block 508: Process, using the retrieval system, the prompt to identify one or more tables in the given database, the one or more tables relevant to the given natural language question.

Block 510: Generate, using the retrieval system, an augmented prompt that comprises the given natural language question, the database schema, and one or more identities of the one or more tables.

Block 512: Generate, using the trained SQL LLM, a set of SQL code based on the augmented prompt.

Block 514: Initiate executing the set of SQL code on the given database and receiving a result.

Block 516: Generate a result message using the result.

Block 518: Provide the result message responsive to the given natural language question.

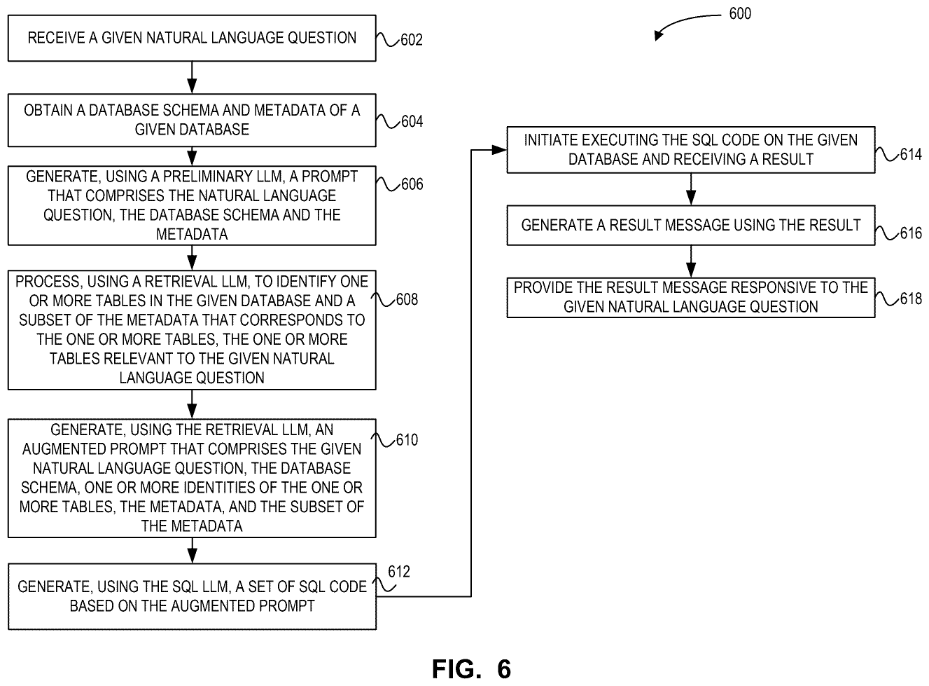

Referring now to FIG. 6, another computing process 600 for processing a natural language question using SQL is provided.

Block 602: Receive a given natural language question.

Block 604: Obtain a database schema and metadata of a given database from amongst the one or more databases.

Block 606: Generate, using a preliminary LLM, a prompt that comprises the given natural language question, the database schema and the metadata.

Block 608: Process, using a retrieval LLM, the prompt to identify one or more tables in the given database and a subset of the metadata that corresponds to the one or more tables, the one or more tables relevant to the given natural language question.

Block 610: Generate, using the retrieval LLM, an augmented prompt that comprises the given natural language question, the database schema, one or more identities of the one or more tables, the metadata, and the subset of the metadata.

Block 612: Generate, using the SQL LLM, a set of SQL code based on the augmented prompt.

Block 614: Initiate executing the SQL code on the given database and receiving a result.

Block 616: Generate a result message using the result.

Block 618: Provide the result message responsive to the natural language question.

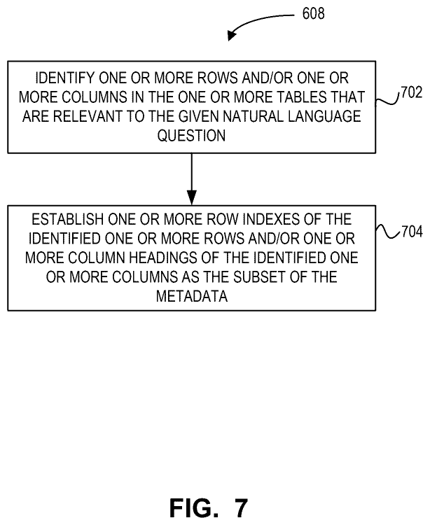

Referring now to FIG. 7, in some cases the process of block 608 includes the following operations.

Block 702: Identify one or more rows and/or one or more columns in the one or more tables that are relevant to the given natural language question.

Block 704: Establish one or more row indexes of the identified one or more rows and/or one or more column headings of the identified one or more columns as the subset of the metadata.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 112a, or 112b). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g. a pushbutton keyboard, mouse, a touchscreen, and the like), and at least one output device (e.g. a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. A computing system for executing a structured query language (SQL) large language model (LLM), the computing system comprising:
a memory, a communication interface, and a processor operatively coupled to the memory and the communication interface;
the SQL LLM stored in the memory and executable by the processor;
the processor configured to:
access a SQL dataset comprising a plurality of natural language questions, metadata for one or more databases associated with each one of the plurality of natural language questions, and a plurality of sets of SQL code respectively associated with the plurality of natural language questions;
generate a synthetic SQL dataset comprising a plurality of synthetic natural language questions, synthetic metadata for the one or more databases associated with each one of the plurality of synthetic natural questions, and a plurality of synthetic sets of SQL code respectively associated with the plurality of synthetic natural questions;
combine the synthetic SQL dataset and the SQL dataset to generate a combined SQL dataset; and
train the SQL LLM on the combined SQL dataset to output a trained SQL LLM.

2. The computing system of claim 1, wherein the processor is further configured to obtain a preference dataset comprising a further plurality of natural language questions, a respective plurality of correct answers, and a respective plurality of incorrect answers;
and, after training the SQL LLM on the combined SQL dataset, further training the SQL LLM using the preference dataset to output a further trained SQL LLM.

3. The computing system of claim 2, wherein the further training the SQL LLM using the preference dataset comprises rewarding the SQL LLM generating training answers that match the respective plurality of correct answers.

4. The computing system of claim 1, wherein a synthesizer LLM uses the SQL dataset to generate the synthetic SQL dataset.

5. The computing system of claim 1, further comprising a retrieval system in the memory, and wherein the processor is further configured to:
receive a given natural language question;
generate a prompt that comprises the given natural language question and a database schema corresponding to a given database from amongst the one or more databases;
process, using the retrieval system, the prompt to identify one or more tables in the database, the one or more tables relevant to the given natural language question;
generate, using the retrieval system, an augmented prompt that comprises the given natural language question, the database schema, and one or more identities of the one or more tables;
generate, using the trained SQL LLM, a set of SQL code based on the augmented prompt;
initiate executing the set of SQL code on the given database and receiving a result;
generate a result message using the result; and
provide the result message responsive to the given natural language question.

6. The computing system of claim 5 further comprising a preliminary LLM in the memory, and the preliminary LLM generates the prompt that comprises the given natural language question, the database schema and metadata of the given database; wherein the retrieval system comprises a retrieval LLM, and the retrieval LLM processes the prompt to identify the one or more tables in the given database and a subset of the metadata of the given database that corresponds to the one or more tables; and wherein the retrieval LLM generates the augmented prompt that further comprises the metadata of the given database and the subset of the metadata of the given database.

7. The computing system of claim 6, wherein the processor is further configured to at least: identify, using the retrieval system, one or more rows in the one or more tables that are relevant to the given natural language question; and establish one or more row indexes of the one or more rows as the subset of the metadata of the given database.

8. The computing system of claim 6, wherein the processor is further configured to at least: identify, using the retrieval system, one or more columns in the one or more tables that are relevant to the given natural language question; and establish one or more column headings of the one or more columns as the subset of the metadata of the given database.

9. The computing system of claim 5, wherein, when the result comprises an error message, the processor is configured to: generate a new set of SQL code, using the trained SQL LLM, based on the augmented prompt; initiate executing the new set of SQL code on the given database; and receive a new result comprising retrieved data from the database that is responsive to the new set of SQL code.

10. The computing system of claim 5, wherein a chat user interface is stored in the memory; and the processor is further configured to:
receive the given natural language question via the chat user interface;
generate the result message in a form of a natural language response that comprises the result; and
provide the natural language response via the chat user interface.

11. A method for executing a structured query language (SQL) large language model (LLM), the method executed in a computing environment comprising one or more processors, a communication interface, and memory that stores the SQL LLM, and the method comprising:
accessing a SQL dataset comprising a plurality of natural language questions, metadata for one or more databases associated with each one of the plurality of natural language questions, and a plurality of sets of SQL code respectively associated with the plurality of natural language questions;
generating a synthetic SQL dataset comprising a plurality of synthetic natural language questions, synthetic metadata for the one or more databases associated with each one of the plurality of synthetic natural questions, and a plurality of synthetic sets of SQL code respectively associated with the plurality of synthetic natural questions;
combining the synthetic SQL dataset and the SQL dataset to generate a combined SQL dataset; and
training the SQL LLM on the combined SQL dataset to output a trained SQL LLM.

12. The method of claim 11, further comprising obtaining a preference dataset comprising a further plurality of natural language questions, a respective plurality of correct answers, and a respective plurality of incorrect answers; and, after training the SQL LLM on the combined SQL dataset, further training the SQL LLM using the preference dataset to output a further trained SQL LLM.

13. The method of claim 12, wherein the further training the SQL LLM using the preference dataset comprises rewarding the SQL LLM generating training answers that match the respective plurality of correct answers.

14. The method of claim 11, wherein a synthesizer LLM uses the SQL dataset to generate the synthetic SQL dataset.

15. The method of claim 11, further comprising, after outputting the further trained SQL LLM:
receiving a given natural language question;
generating a prompt that comprises the given natural language question and a database schema corresponding to a given database from amongst the one or more databases;
processing, using a retrieval system, the prompt to identify one or more tables in the given database, the one or more tables relevant to the given natural language question;
generating, using the retrieval system, an augmented prompt that comprises the given natural language question, the database schema, and one or more identities of the one or more tables;
generating, using the trained SQL LLM, a set of SQL code based on the augmented prompt;
initiating executing the set of SQL code on the given database and receiving a result;
generating a result message using the result; and
providing the result message responsive to the given natural language question.

16. The method of claim 15 further comprising a preliminary LLM generating the prompt that comprises the given natural language question, the database schema and metadata of the given database; wherein the retrieval system comprises a retrieval LLM, and the retrieval LLM processes the prompt to identify the one or more tables in the given database and a subset of the metadata of the given database that corresponds to the one or more tables; and wherein the retrieval LLM generates the augmented prompt that further comprises the metadata of the given database and the subset of the metadata of the given database.

17. The method of claim 16, further comprising: identifying, using the retrieval system, one or more rows in the one or more tables that are relevant to the given natural language question; and establishing one or more row indexes of the one or more rows as the subset of the metadata of the given database.

18. The method of claim 16, further comprising: identifying, using the retrieval system, one or more columns in the one or more tables that are relevant to the given natural language question; and establishing one or more column headings of the one or more columns as the subset of the metadata of the given database.

19. The method of claim 15, wherein, when the result comprises an error message, the method further comprising: generating a new set of SQL code, using the trained SQL LLM, based on the augmented prompt; initiating executing the new set of SQL code on the given database; and receive a new result comprising retrieved data from the given database that is responsive to the new set of SQL code.

20. A non-transitory computer readable medium storing computer executable instructions which, when executed by at least one computer processor, cause the at least one computer processor to carry out a method for executing a structured query language (SQL) large language model (LLM), the method comprising:
accessing a SQL dataset comprising a plurality of natural language questions, metadata for one or more databases associated with each one of the plurality of natural language questions, and a plurality of sets of SQL code respectively associated with the plurality of natural language questions;
generating a synthetic SQL dataset comprising a plurality of synthetic natural language questions, synthetic metadata for the one or more databases associated with each one of the plurality of synthetic natural questions, and a plurality of synthetic sets of SQL code respectively associated with the plurality of synthetic natural questions;
combining the synthetic SQL dataset and the SQL dataset to generate a combined SQL dataset; and
training the SQL LLM on the combined SQL dataset to output a trained SQL LLM.
